(19) United States
(12) Patent Application Publication
(10) Pub. No.: US 2016/0171105 A1
(43) Pub. Date: Jun. 16, 2016

(54) SYSTEMS AND METHODS FOR LOCATING USER AND ACCOUNT INFORMATION

(71) Applicant: VONAGE NETWORK, LLC, HOLMDEL, NJ (US)

(72) Inventors: JONATHAN ALEXANDER, ROSWELL, GA (US); STEVEN LANDERS, ALPHARETTA, GA (US)

(21) Appl. No.: 14/566,047

(22) Filed: Dec. 10, 2014

(51) Int. Cl. G06F 17/30

(52) U.S. Cl. CPC G06F 17/30867

(57) ABSTRACT

When user and/or account information is split between different databases located in different application clusters, each application cluster is capable of performing a lookup to determine an identity of the application cluster that has a particular user's information. As a result, if a first application receives a request for a user's information from a software application, and the first application cluster does not itself have the user's information, the first application can determine the identity of a second application cluster that does have the user's information, and the first application cluster can refer the requesting software application to the second application cluster.

### BACKGROUND OF THE INVENTION

The invention is related to computer systems that store user and account information. More specifically, the invention is related to systems and methods for locating user and account information that is stored in databases.

Although the following description uses an Internet protocol (IP) telephony system as an example of a system that creates, stores and utilizes user and account information, the systems and methods disclosed in the present application have applicability in a wide range of different computer systems configured to accomplish various different functions. Thus, the description of an IP telephony system should in no way be considered limiting of the invention.

An IP telephony system stores user and account information in various databases. The account information could be for a single user's account, for a family account that includes multiple users, or for a business account that also includes multiple users. As the IP telephony system grows, so too do the databases that store user and account information. As more and more information is added to those databases, it eventually makes sense, or becomes necessary, to separate a single large database into two or more smaller databases. However, once this occurs, it can create problems with locating the correct database to query in order to obtain a particular user's information or a particular account's information.

For example, an IP telephony system could provide its users with one or more software applications that enable the users to lookup and modify their user information within the system. Similarly, an IP telephony system could provide a business customer with one or more software applications that enable a system administrator of the business to lookup and modify the business' account information. Such software applications must include information indicating the locations of the databases containing the user and account information in order for the software application to obtain and modify the data stored in those databases. The database location information is often hard-coded into the software applications.

When database location information is hard-coded into a software application, and the location of a database thereafter changes, it may be impossible for the software application to then locate and update user and account information stored in the database. As noted above, the location of user and account databases could change if an IP telephony system that is steadily growing decides to separate a single user or account database into multiple separate databases. For example, a first user's information could be moved from a first database stored at a first location into a second database stored in a second location. When this occurs, a software application provided to the user and hard-coded with information about how to locate the first database will be unable to locate and access the second database at the second location. As a result, the user's software application will no longer be able to access and update the user's information.

One way of overcoming this problem is to provide the user with an updated version of the software application that he uses to access and update his information whenever the location of the database containing the user's information changes. The updated version of the software application would be hard-coded with the new database location information. Pushing out such software updates, however, can be expensive and time consuming. It also may require the active participation of the user to install the updated version of the software application on the user's relevant computing devices. If the user fails to install the updated software application on a timely basis, the user could still experience difficulty in accessing and updating his information.

What is needed is an alternate way of ensuring that software applications that are used to access and update user and account information can always locate the necessary user and account information databases, even after the user/account information has been moved from a first database at a first location to a second database at a second location.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 is a diagram of a communications environment where both businesses and individual users utilize an IP telephony system to send and receive telephony communications;

FIG. 3 is a block diagram of selected elements of an application cluster that could form a part of an IP telephony system;

FIG. 4 is a diagram of various elements of a processor that forms part of an IP telephony system, an application cluster, or an IP telephony device according to an embodiment of the invention;

FIG. 5 illustrates steps of a method of processing a user or account login request according to an embodiment of the invention;

FIG. 6 illustrates steps of a first method embodying the invention for determining an identity of an application cluster that includes one or more local databases with information about a user or account; and

FIG. 7 illustrates steps of a second method embodying the invention for determining an identity of an application cluster that includes one or more local databases with information about a user or account.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

References to an “IP telephony device” appear in both the foregoing and following descriptions. This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

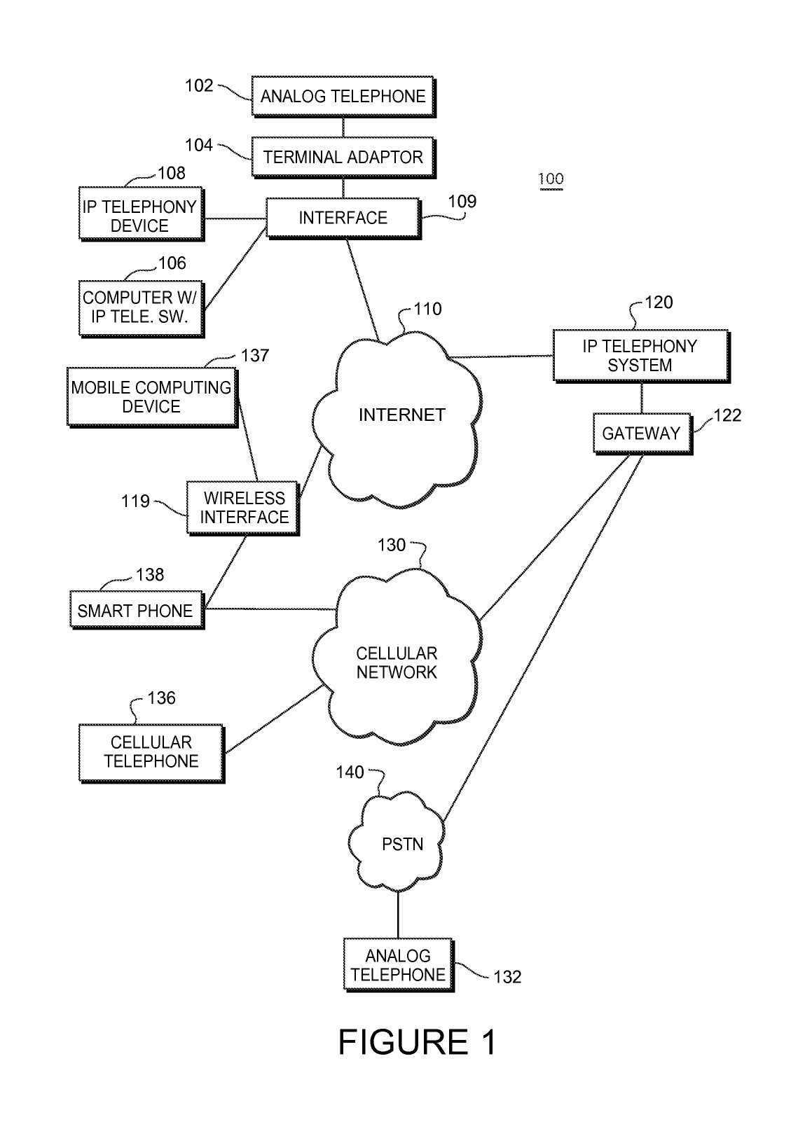

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software 106 would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software could also be used to place and receive telephone calls through the IP telephony system 120. The mobile computing device 137 accesses the Internet 110 via a wireless data network interface 119. The wireless data network interface could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 140 or cellular network 130.

Many businesses that require telephony service utilize a private branch exchange system which connects telephones within the business to outside telephone lines. In the past, private branch exchange systems were specialized systems that were physically installed at a business. The incoming telephone lines were connected to the private branch exchange system, as were the telephones at the business. When an incoming call to the business was received on one of the telephone lines, the private branch exchange system was capable of connecting the call to any of the telephones within the business.

With the advent of Internet protocol telephony systems, it is now possible to replace a typical private branch exchange system with a remotely implemented, Internet protocol based virtual private branch exchange system. In this sort of an arrangement, the telephones within a business are IP telephones that are simply connected to a data network, such as the Internet. Alternatively, IP software applications on computers or smartphones can be utilized to send and receive telephony communications over the virtual private branch exchange system. Gateways and servers operated by an IP telephony system, which can be located virtually anywhere, route incoming calls to the business' telephones or IP telephony software applications over a data network. Likewise, the IP telephony system sets up outgoing calls for the business' telephones and/or IP telephony software applications via the data network.

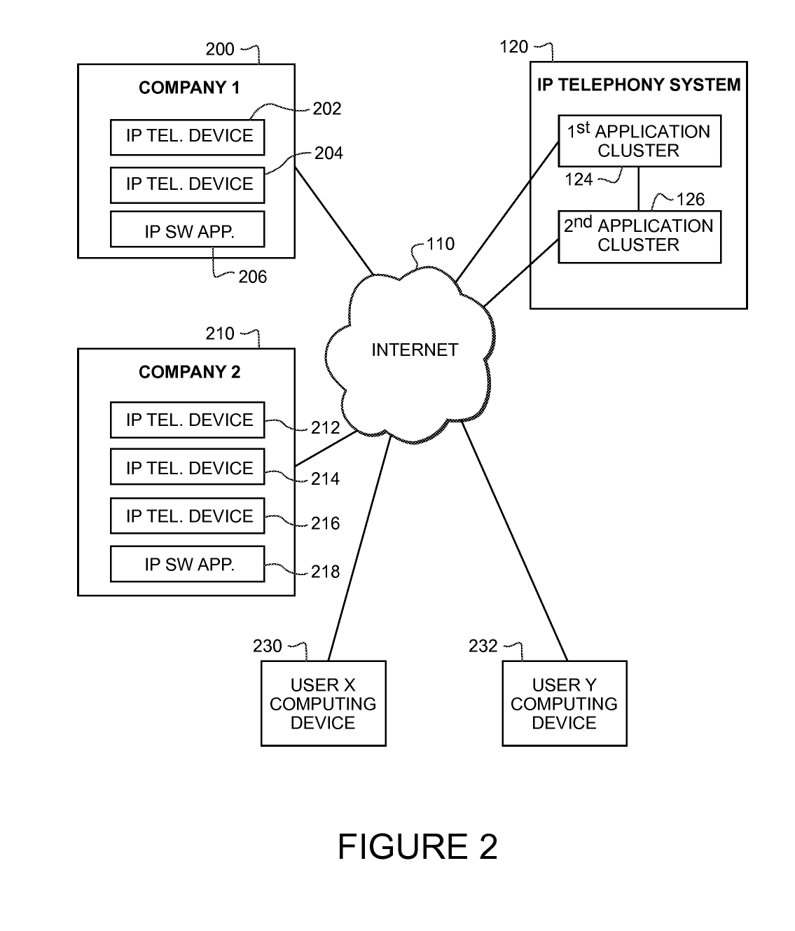

FIG. 2 illustrates a communications environment that includes two businesses which make use of telephony services provided by an IP telephony system 120. A first company 200 has first and second IP telephony devices 202, 204 that send and receive telephony communications via the IP telephony system 120. A second company 210 includes first, second and third IP telephony devices 212, 214 and 216 that send and receive telephony communications via the IP telephony system. The first and second companies could also utilize IP telephony software applications that are running on a computer or a smartphone to send and receive telephony communications via the IP telephony system 120.

The first company also has an IP software application 206 that was provided by the IP telephony system 120. The IP software application 206 provides various forms of functionality to the users and/or administrators of the first company 200. The IP software application 206 could be used to access and modify various items of user or account information stored at the IP telephony system 120. For example, a user or administrator at the first company 200 could utilize the IP software application 206 to request the addition or deletion of new users or telephone numbers, to modify user or account information; to request the addition or deletion of new services or features, and to accomplish various other user or account functions. For example, an administrator could use the IP software application 206 to assign features to specific users or extensions, to change settings such as call blocking rules, call recording rules, company greetings, call routing rules, and various other settings. Individual users could also change various settings, such as voicemail greetings, call forwarding rules, call screening. An IP software application 206 might also be used to provide a user with access to voicemail recordings, call logs, and other information that is specific to a user. In other instances, a software application might be used to provide various capabilities such as e-faxing or video/web conferencing. The second company 210 also includes an IP software application 218 that provides similar functionality to users and administrators at the second company 210.

Although FIG. 2 illustrates only a single IP software application within the first company 200 and the second company 210, in alternate embodiments, a single company could have multiple different IP software applications that provide various different types of functionality. For example, an administrator at a company could be provided with a first IP software application that allows managers and administrators to manage their account with the IP telephony system. Users at the company could be provided with a different type of IP software application that allows them to manage their own user information, and to selectively modify how their telephony service is accessed and used.

Moreover, if a company or user has an IP telephony software application that allows the user or company to send and receive telephony communications via the IP telephony system 120, using a computer or smartphone, that same software application may include functionality that allows a user to perform the functions described above.

FIG. 2 also illustrates that user X has a computing device 230, and that user Y has a computing device 232. User X and user Y may be individual users who maintain individual accounts with the IP telephony system 120. An IP software application on user X's computing device 230 and an IP software application on user Y's computing device 232 provide those users with similar functionality in managing their accounts with the IP telephony system 120. The same software application could be used to place and receive telephony communications via the IP telephony system 120.

FIG. 2 also illustrates that the IP telephony system 120 includes a first application cluster 124 and a second application cluster 126. As mentioned in the background section of the application, as an IP telephony system 120 grows and adds users, it may ultimately become necessary to split larger account and user databases into multiple different smaller account and user databases. When this occurs, the information for some users and accounts is stored in the first application cluster 124 and the information for other users and accounts is stored in the second application cluster 126. Each application cluster may also include gateways and servers that allow the application clusters to provide telephony service to users, and to perform various accounting functions to bill clients for the provided telephony services.

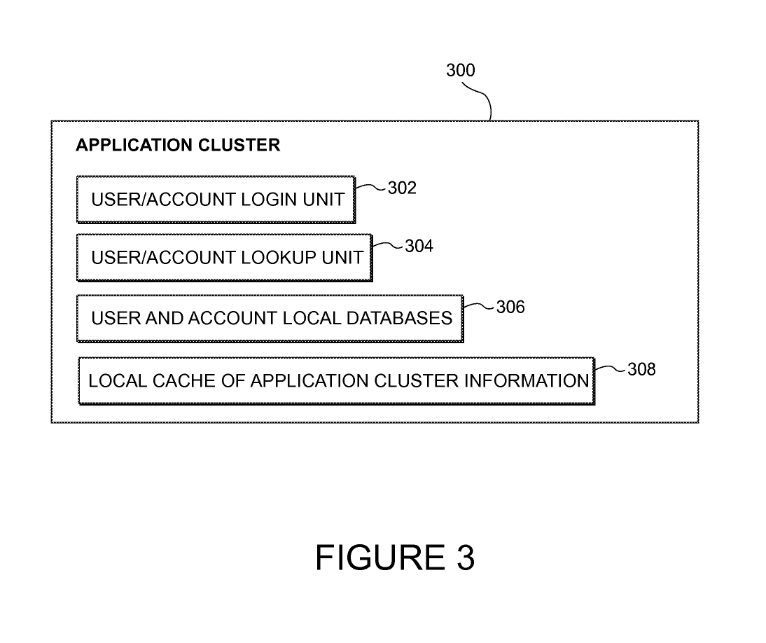

FIG. 3 illustrates some elements of a typical application cluster 300. The application cluster includes a user/account login unit 302 that receives a user or account login request from an IP software application that is being used by a user or account administrator. The application cluster 300 also includes a user/account lookup unit 304 that determines whether a user's information is present in one or more local databases 306 of the application cluster. If not, the user/account lookup unit 304 may act to determine the identity of a different application cluster that does include one or more databases that have information regarding a particular user or account, as will be explained below. The application cluster also includes a local cache 308 of information that cross-references user/account identifiers to the application clusters that contain information relating to those users/accounts.

In some embodiments, a single user/account login unit 302 operates to login both individual users, and account administrators that are seeking to access, change or update account information. In alternate embodiments, an application cluster could include both a user login unit and a separate account login unit. Similarly, in some embodiments a single user/account lookup unit 304 is provided to determine the identity of an alternate application cluster that includes a user's information or an account's information. In alternate embodiments, an application cluster could include both a user lookup unit and a separate account lookup unit.

FIG. 3 depicts only selected elements of an application cluster 300 that are relevant to a discussion of the claimed systems and methods. However, an application cluster 300 could also include a variety of other units that perform different functions. For example, an application cluster could include various units that act to setup incoming and outgoing calls for users, and that track usage and billing information. Also, an application cluster may not include all of the features depicted in FIG. 3. Thus, the depiction provided in FIG. 3 should in no way be considered limiting of the elements present in an application cluster.

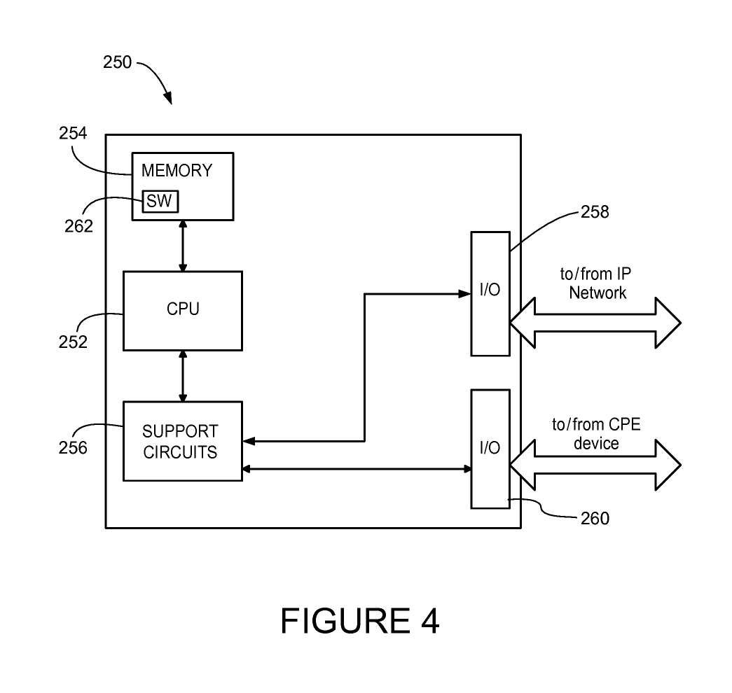

FIG. 4 illustrates elements of a computer processor 250 that can be used as part of an IP telephony system 120, an application cluster 300, or a telephony device to accomplish various functions. An IP telephony system 120 or an application cluster 300 could include multiple processors 250 located at various locations, along with their operating components and programming, each carrying out a specific or dedicated portion of the functions performed by the IP telephony system 120 or application cluster 300.

The processor 250 shown in FIG. 4 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 4; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120, an application cluster 300 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

As mentioned above in the background section of the application, when user and/or account information for an IP telephony system is split between different application clusters, it can cause problems for a user that is attempting to access his user or account information. Specifically, an IP software application that has been provided to the user may be hard-coded to contact a first application cluster to retrieve information or to perform various functions. If the user or account information for that user has been moved to a second application cluster, then any requests sent to the first application cluster are not likely to be successful. The systems and methods described below address this problem, and provide ways for an IP software application to be re-directed to the application cluster that includes the user and account information that is being sought.

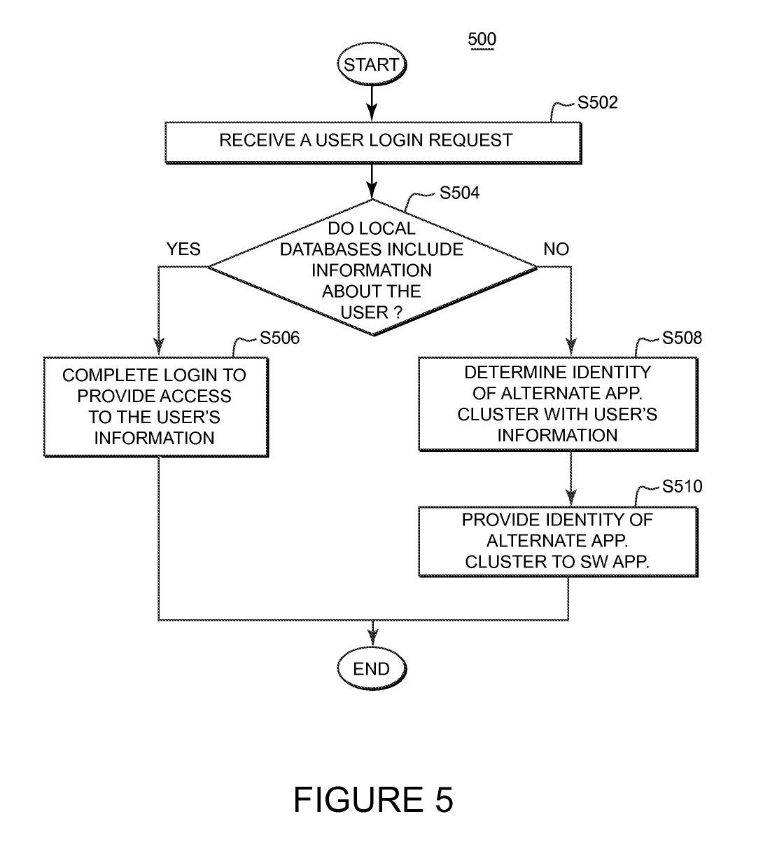

In the following description, and FIGS. 5-7, methods of accessing, obtaining and/or modifying user information are discussed. Likewise, the claims of the present application refer to information about a user, and to a user identifier. The same basic methods could be used to access, obtain and modify account information using an account identifier. For this reason, the term “user information” or “information about a user” should be construed to also cover “account information” and “information about an account.”

FIG. 5 illustrates steps of a method of processing a user login request that has been received from an IP software application. The user login request would be received by a user login unit 302 of an application cluster 300.

The method 500 begins and proceeds to step S502, where the user login unit 302 of an application cluster receives a user login request. The user login request includes a user identifier. In step S504, a check is performed, making use of the received user identifier, to determine if the user's information is present in one or more local databases within the application cluster. If so, the method proceeds to step S506, and the login process is completed so that the IP software application can access the user's information. As explained above, the IP software application may be seeking to review, modify, update or otherwise change the user information. The method then ends.

If the check performed in step S504 indicates that the user's information is not present in the local databases, the method proceeds to step S508, where a user lookup unit 304 of the application cluster determines an identity of a different application cluster that has one or more local databases that contain the user's information. Here again, the received user identifier could be used to help make this determination. Then, in step S510, the identity of the application cluster that has the user's information is provided to the IP software application, and the IP software application is instructed to contact that other application cluster in order to proceed with the functions being performed for or by the user. The method then ends.

With a method as described above, the IP software application that is used to access or modify a user's information can continue to have address information directing the IP software application to a first application cluster, even after the user's information has been moved to second application cluster. If the user's information is no longer stored at the first application cluster, the user lookup unit present at the first application cluster will locate the address information for the second application cluster that does have the user's information, and the IP software application will then be redirected to that second application cluster. Thus, there is no need to update a user's IP software application each time the user's information is moved from a first application cluster to a second application cluster.

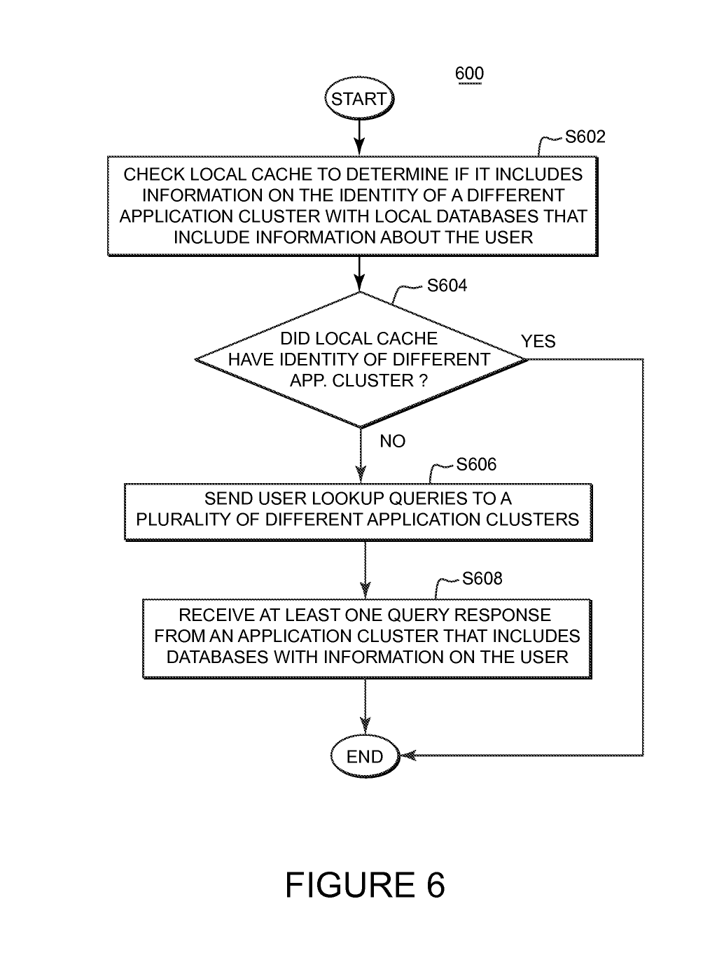

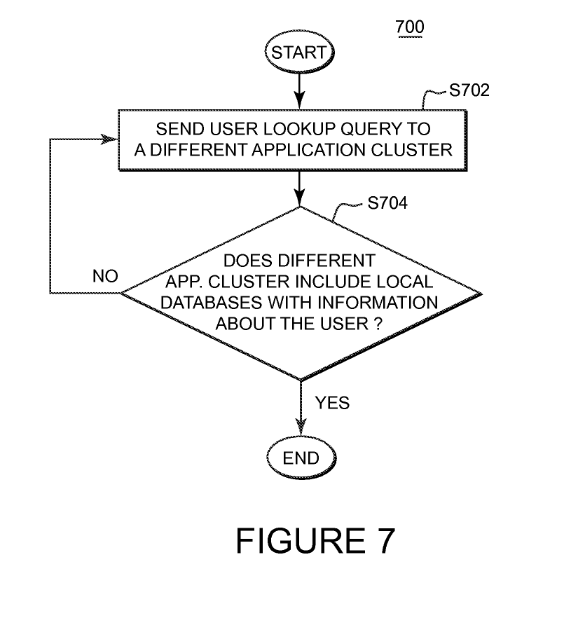

In the method described above in connection with FIG. 5, step S508 involved a user lookup unit 304 of a first application cluster 300 determining what other application cluster has one or more local databases that include a user's information. FIGS. 6 and 7 depict steps of two alternate methods of making this determination.

The method 600 illustrated in FIG. 6 begins at step S602, where a user lookup unit 304 first checks in a local cache 308 of the application cluster 300 to determine if there is any information in the local cache 308 that identifies a different application cluster as containing the user's information. This check may be performed using the received user identifier. The local cache 308 contains information that previously has been acquired by sending queries to other application clusters during earlier attempts to locate a different application cluster that contains a certain user's information. If the same application cluster has previously sought out and identified a different application cluster as containing a certain user's information, information about that different application cluster is stored in the local cache 308. Information identifying the other application cluster then can be more rapidly obtained by consulting the local cache 308, as opposed to sending queries to other application clusters, and waiting for the other application clusters to respond.

In step S604, a check is performed to determine if the check of the cache 308 revealed the existence of a different application cluster that contains the user's information. If so, the method ends. Or perhaps more specifically, the method illustrated in FIG. 5 continues on to step S510, and information identifying the different application cluster is provided to the IP software application to redirect the IP software application to the different application cluster.

If information identifying the appropriate application was not found in the local cache 308, the method proceeds to step S606, where the user lookup unit 304 of the application cluster 300 sends queries to one or more other application clusters to ask if they have the user's information stored in their databases. Next, in step S608, the user lookup unit 304 receives at least one response from a different application cluster that indicates that the different application cluster has the user's information stored in its local databases. In some embodiments, all of the application clusters that are queried may send a response to the user lookup unit 304. Presumably, all but one of those responses would be negative, and the one application cluster that does have the user's information would respond in a positive fashion. In alternate embodiments, only the application cluster that includes the user's information would respond. Operating in this second fashion may decrease the amount of signaling traffic passing between the application clusters. Once the application cluster that has the user's information has been located, the method then ends.

The queries sent from a first application cluster to other application clusters, and any response messages, could be sent over a public data network such as the Internet. Alternatively, the messages could traverse a private data network to which all or some of the application clusters are connected.

If it was necessary for the method to proceed through steps S606 and S608 to determine the identity of a different application cluster that includes the user's identity, information about the different application cluster, and the corresponding user's identifier, may be stored in a local cache 308 of the application cluster. As explained above, storing the information in the local cache 308 can speed up the process of locating the correct application cluster if the same user's IP software application later tries again to login.

FIG. 7 illustrates steps of an alternate method 700 for determining which application cluster contains a user's information. In step S702, the user lookup unit 702 sends a first query to a first different application cluster to ask if the first different application cluster contains the user's information. Here again, the query would include the received user identifier. Next, in step S704 a response message from the first different application cluster is reviewed to determine if the first different application cluster has the user's information. If so, the method ends. If not, the method loops back to step S702, and a new query is sent to a new different application cluster. Steps S702 and S704 are repeated until a queried application cluster responds affirmatively, indicating that it has the user's information. The method then ends.

Note, in the method illustrated in FIG. 7, a check might first be performed in a local cache 308 of an application cluster 300 before a query is sent to a different application cluster. Also, once the correct application cluster has been determined, that information could be stored in a local cache 308 of the application cluster 300 that performed the lookup method.

In some embodiments, the information about a different application cluster that is passed back to the IP software application is an IP address for a login unit of the different application cluster. In alternate embodiments, the different application cluster could be identified in some other fashion.

Some of the above description assumes that a software application is hard coded with an IP address, and that the software application can be redirected to a different IP address based on information that is provided to the software application. In other embodiments, a user may be provided with an IP address or URL that the user types into an Internet browser to access information at an application cluster. In this situation, it would be common for the user to create a “bookmark” to the IP address or URL, which would make it easy for the user to return to the IP address or URL on a regular basis. If the information that the user is seeking has been moved from the original IP address or URL to a new location, the application cluster could provide a message or information to the user's browser software to redirect the browser to an alternate IP address or URL. This redirection could be accomplished via an HTTP redirect message, or via alternate means. Operating in this fashion would eliminate the need to advise the user when information is moved from a first IP address or URL to a new IP address or URL. The user could continue to use the original IP address or URL, and the user's browser would automatically be redirected.

Because it is possible to redirect Internet browser software or a software application via a typical HTTP redirect message, it is never necessary to make any modifications to the user's software application, or even to a bookmarked URL or IP address that has been stored in a user's browser. And because no changes need be made to the user's software application or stored browser information, redirection to a new location can be accomplished without any user action, participation or intervention.

Although the foregoing description used an Internet protocol (IP) telephony system as an example of a system that creates, stores and utilizes user and account information, the systems and methods disclosed in the present application have applicability in a wide range of different computer systems configured to accomplish various different functions. Thus, the description of an IP telephony system should in no way be considered limiting of the invention. The same basic systems and methods disclosed herein could be used on many types of computer systems other than IP telephony systems.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of processing a user login request received from a software application, comprising:
receiving, at a first application cluster, a user login request from a software application, the user login request including a user identifier;
determining, using the received user identifier, that one or more local databases within the first application cluster do not include information about the user;
determining, using the received user identifier, the identity of a second application cluster that includes one or more local databases that include information about the user, and thereafter sending information about the second application cluster to the software application.

2. The method of claim 1, wherein determining the identity of a second application cluster that includes one or more local databases that include information about the user comprises:
sending a plurality of user lookup queries that include the user identifier to a corresponding plurality of other application clusters; and
receiving a response to at least one of the user lookup queries from an application cluster that has one or more local databases that include information about the user.

3. The method of claim 2, wherein receiving a response to at least one of the user lookup queries comprises receiving a response from only a single application cluster that has one or more local databases that include information about the user.

4. The method of claim 2, wherein sending a plurality of user lookup queries comprises sending the plurality of lookup queries to the plurality of other application clusters at approximately the same time.

5. The method of claim 1, wherein determining the identity of a second application cluster that includes one or more local databases that include information about the user comprises:
sending a user lookup query that includes the user identifier to a different application cluster;
receiving a response from the different application cluster that indicates whether the different application cluster has one or more local databases that include information about the user; and
repeating the sending and receiving steps for another different application cluster when the received response indicates that the different application cluster does not have one or more local databases that include information about the user until a response from one of the different application clusters indicates that the different application cluster has one or more local databases that include information about the user.

6. The method of claim 1, wherein determining the identity of a second application cluster that includes one or more local databases that include information about the user comprises checking a local cache within the first application cluster using the received user identifier to determine if the cache includes information identifying a different application cluster that has one or more local databases with information about the user.

7. The method of claim 6, wherein when the local cache does not include information identifying a different application cluster that has one or more local databases with information about the user, determining the identity of a second application cluster that includes one or more local databases that include information about the user further comprises sending a user lookup query that includes the user identifier to at least one different application cluster to determine if the different application cluster includes one or more local databases that include information about the user.

8. The method of claim 7, wherein sending a user lookup query that includes the user identifier to at least one different application cluster comprises:
sending a plurality of user lookup queries that include the user identifier to a corresponding plurality of other application clusters; and
receiving a response to at least one of the user lookup queries from an application cluster that has one or more local databases that include information about the user.

9. The method of claim 1, further comprising storing, in a local cache within the first application cluster, information about an identity of a second application cluster that includes one or more local databases that include information about the user.

10. A system for processing a user login request received from a software application, comprising:
means for receiving, at a first application cluster, a user login request from a software application, the user login request including a user identifier;
means for determining, using the received user identifier, that one or more local databases within the first application cluster do not include information about the user; and
means for determining, using the received user identifier, the identity of a second application cluster that includes one or more local databases that include information about the user, and for thereafter sending information about the second application cluster to the software application.

11. A system for processing a user login request received from a software application, comprising:
a user login unit that receives, at a first application cluster, a user login request from a software application, the user login request including a user identifier; and
a user lookup unit that determines, using the received user identifier, that one or more local databases within the first application cluster do not include information about the user, wherein the user lookup unit also determines, using the received user identifier, the identity of a second application cluster that includes one or more local databases that include information about the user, and wherein the user lookup unit thereafter sends information about the second application cluster to the software application.

12. The system of claim 11, wherein the user lookup unit determines the identity of a second application cluster that includes one or more local databases that include information about the user by:
sending a plurality of user lookup queries that include the user identifier to a corresponding plurality of other application clusters; and
receiving a response to at least one of the user lookup queries from an application cluster that has one or more local databases that include information about the user.

13. The system of claim 12, wherein the user lookup unit receives a response from only a single application cluster that has one or more local databases that include information about the user.

14. The system of claim 12, wherein the user lookup unit sends a plurality of user lookup queries to the plurality of other application clusters at approximately the same time.

15. The system of claim 11, the user lookup unit determines the identity of a second application cluster that includes one or more local databases that include information about the user by:
sending a user lookup query that includes the user identifier to a different application cluster;
receiving a response from the different application cluster that indicates whether the different application cluster has one or more local databases that include information about the user; and
repeats the sending and receiving steps for another different application cluster when the received response indicates that the different application cluster does not have one or more local databases that include information about the user until a response from one of the different application clusters indicates that the different application cluster has one or more local databases that include information about the user.

16. The system of claim 11, wherein the user lookup unit determines the identity of a second application cluster that includes one or more local databases that include information about the user by checking a local cache within the first application cluster using the received user identifier to determine if the cache includes information identifying a different application cluster that has one or more local databases with information about the user.

17. The system of claim 16, wherein when the local cache does not include information identifying a different application cluster that has one or more local databases with information about the user, the user lookup unit determines the identity of a second application cluster that includes one or more local databases that include information about the user by sending a user lookup query that includes the user identifier to at least one different application cluster to determine if the at least one different application cluster includes one or more local databases that include information about the user.

18. The system of claim 17, wherein the user lookup unit sends a plurality of user lookup queries that include the user identifier to a corresponding plurality of other application clusters, and receives a response to at least one of the user lookup queries from an application cluster that has one or more local databases that include information about the user.

19. The system of claim 11, wherein the user lookup unit stores, in a local cache within the first application cluster, information about an identity of a second application cluster that includes one or more local databases that include information about the user.
